(19) United States
(12) Patent Application Publication
(10) Pub. No.: US 2007/0230195 A1
(43) Pub. Date: Oct. 4, 2007

(54) Foldable harp

(75) Inventor: Gary Hui, Kowloon (CN)

Correspondence Address: DENNIS B. HAASE, P.O. BOX 6206, HOT SPRINGS, AR, 71902-6206, US

(73) Assignee: Mastercraft International USA, Inc.

(21) Appl. No.: 11/391,484

(22) Filed: Mar. 29, 2006

(51) Int. Cl. F21V 17/00

(52) U.S. Cl. 362/417; 362/450

(57) ABSTRACT

A foldable harp for use on a lamp having an illuminating element with a shade, or the like, surrounding the illuminating element, the harp having foldable leg portions which, when folded, substantially reduce the size and thickness of the harp for shipping and storage.

The present invention relates to lamps of all kinds which include a shade, irrespective of the size or shape, and, more particularly, to the harp for such lamps which supports a shade about the illuminating element thereof.

### BACKGROUND OF THE INVENTION

1. Field of the Invention

In the vast majority of lamps having shades about the illuminating element, or bulb, are supported in their place by an element referred to as a harp, so named because of their shape.

At one time the importation of lamps was relatively unusual, and it was not common to import thousands of lamp elements at a time in shipping containers the size of box cars or trailer vans. With the burgeoning of the Pacific Rim countries as a source for lamps in quantities sufficient to fill a container, that has changed significantly.

Space in a container becomes precious when shipping costs are a significant element of the overall cost, and sellers of such products are increasingly conscious of size of such things as shades and harps. While the typical harp is flat in one dimension, they vary considerably in length and that dimension is the focus of the present invention.

2. Overview of the Prior Art

A search of the appropriate art has turned up but one single patent relating to foldable harps. That patent issued to Humphrey as U.S. Pat. No. 6,886,966. Humphrey has obtained patent protection on what he refers to as a collapsible lamp harp. The legs of the harp are hinged about a hinge pin which lies in an axis which is transverse to the plane of the harp. Accordingly, the lower leg folds on top of the upper leg and the depth of the folded harp is essentially doubled. Catches on the lower leg engage grooves in the upper leg to limit travel of the lower leg.

### SUMMARY OF THE INVENTION

The present invention addresses the issue of packaging and shipping costs by creating a foldable harp for use with lamps, or the like, which use shades over the illuminating element, and which is capable of being folded into an exceptionally compact unit for packaging, shipping and storage.

An objective, therefore, of the present invention is to provide a space saving harp which is capable of being cost effective to be shipped long distances and stored in large quantities at minimal cost.

It is a further objective to provide a harp for lamps, or the like, which is inexpensive to manufacture, readily assembled by anyone, and capable of supporting even the heaviest of shades.

Other objectives and advantages of the present invention will become apparent from a reading of the forthcoming Detailed Description of a Preferred Embodiment, taken in conjunction with the drawings, wherein:

### DESCRIPTION OF THE DRAWINGS

FIG. 1 is a pictorial representation of a harp constructed in accordance with the present invention and shown in perspective;

FIG. 2 is a side elevation of the harp of FIG. 1;

FIG. 3 is a partial sectional view of a portion of one of the legs of the harp of FIG. 1, illustrating, in some detail, the hinge structure in its erect mode;

FIG. 4 is a view similar to that of FIG. 1, illustrating the legs of the harp in their folded state;

FIG. 5 is a side elevation of the harp of FIG. 4;

FIG. 6 is a partial sectional view, similar to that of FIG. 3, but with the legs partially folded;

FIG. 7 is a view similar to that of FIG. 6, with the legs fully folded and illustrating the positioning stops; and

FIG. 8 is an exploded view of the hinge assembly of the harp of the present invention.

### DETAILED DESCRIPTION OF A PREFERRED EMBODIMENT

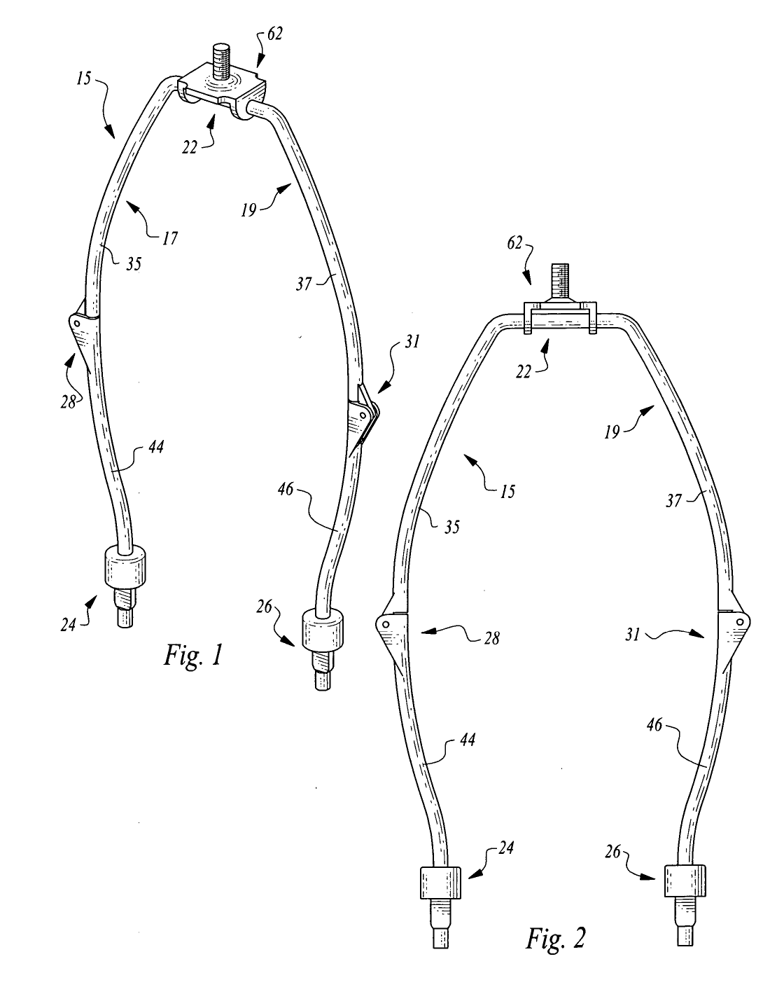

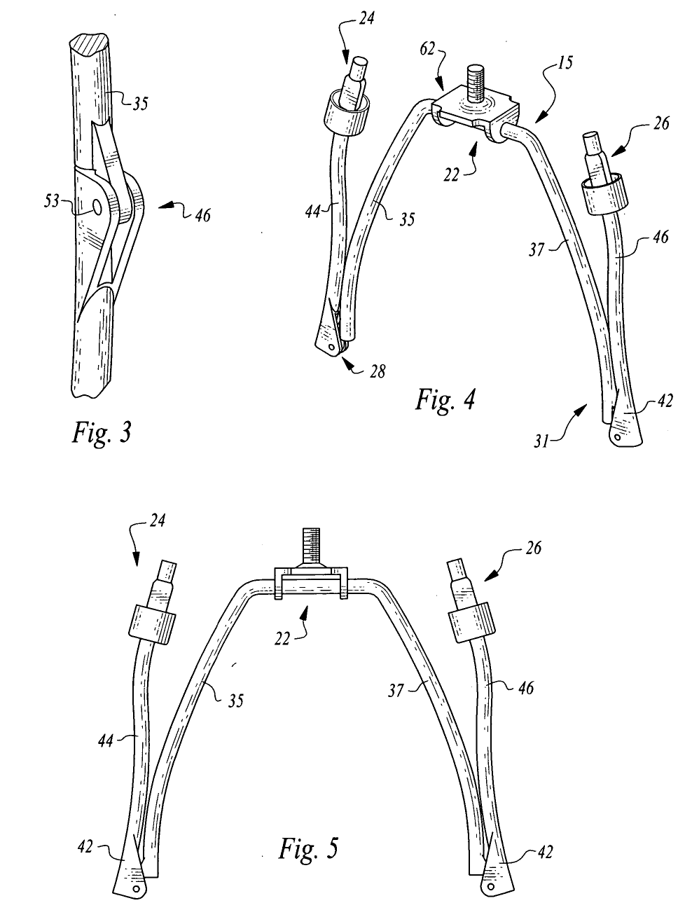

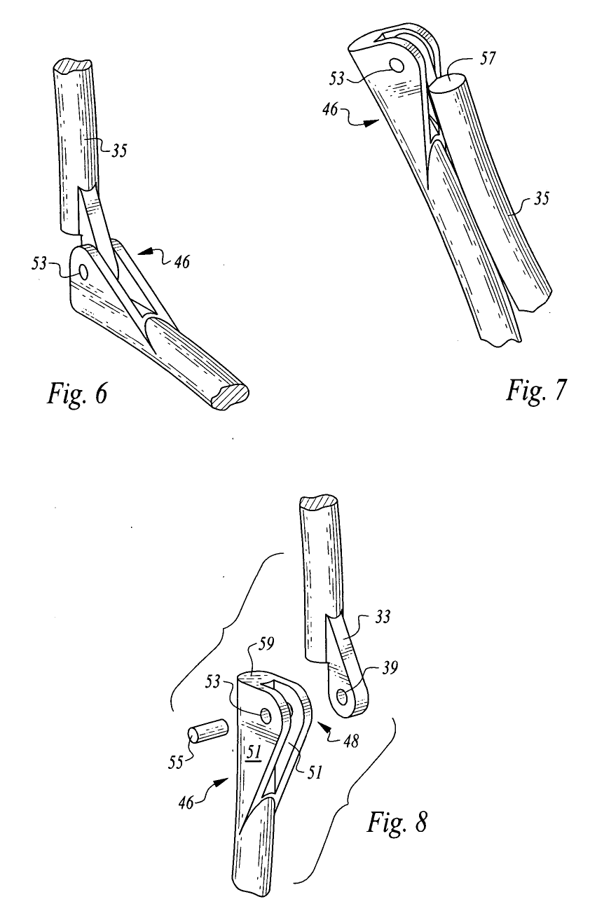

With reference now to the drawings and initially to FIG. 1, a harp 15, for use in support of a shade is shown and is constructed in accordance with the present invention.

The environment which supports the harp is found in the decorative lighting industry where floor and table lamps abound in all shapes and sizes and typically support a shade of some sort which defuses light emanating from an illuminating source. A harp, such as harp 15, is a device which supports the shade about an illuminating device in a lamp or the like.

The harp, in the scheme of things, generally resembles existing harps wherein a pair of legs 17 and 19 depend from an apex 22 and are bowed outwardly so as to fit comfortably about an illuminating element, such as an incandescent bulb in a lamp. The remote ends 24 and 26 of the legs are configured to be received in receptacles in the lamp hardware beneath the illuminating element.

The essence of the present invention is to provide a harp for the lighting industry which is cost effective to pack and ship extended distances such as, e.g., from the Pacific Rim. To that end, it is important that it take up as little space as possible, while being capable of readily functioning for the purpose intended.

In accomplishing this objective, each of the legs 17 and 19 are provided with a hinge 28 and 31. Each hinge is preferably situated at approximately half way down each leg. Each hinge 28, 31 comprises a narrowed boss 33 formed on the lower extremity of each of the upper half 35, 37 of the legs 17, 19, extending outwardly therefrom. Each boss is formed with an aperture 39 which is on an axis transverse to the plane of the legs 17, 19.

The complimentary portion of the hinge is formed on the upper end 42 of the lower half 44, 46, where a clevis-like element 48 is formed. A pair of upstanding sidewalls 51 define a slot between them for receipt of the boss 33, and an aperture 53 is formed in the side walls and aligns with the aperture in the boss. The boss and clevis element are engaged and held by a hinge pin 55, which is oriented transverse to the plane of the harp.

It is an important feat of the harp of the present invention that it be repeatably extensible and retractable to the same position. Referring now to FIGS. 4 and 5, it will be quickly observed that by folding the lower half 44, 46 outwardly and upwardly, in the plane of the harp, about the hinge pin 55 to a position in contact with the upper half of the legs 35, 37, with all of the leg halves in a single plane, the size and depth, or thickness, in the plane of the harp is significantly reduced for shipping and storage.

Similarly, by extending the lower halves of the legs to an “in use” position, the ends of the leg halves, which are formed with a land 57 on the upper half 35, 37 and a land 59 on the lower halves of the legs 44, 46, abut to repeatably limit travel and provide strong legs for the harp in order that a shade may be secured to the harp by mounting the same on a shade support, known in the industry as a finial, 62.

It will be appreciated that some variation in the precise structure may be perceived. However, such variations are with in the contemplation of the invention which is defined by the scope of the following claims wherein:

1. In a lamp, or the like, having an illuminating element circumscribed by a shade, a foldable harp to support the shade;
said harp comprising a pair of legs, said legs being hinged near the middle of said legs so as to divide said legs into upper halves and lower halves of said legs, said legs such that the lower halves of said legs are foldable outwardly and upwardly into contact with said upper halves such that said entire harp resides in a single plane for shipment and storage;
said lower halves being extensible to a position which supports a shade on the lamp.

2. (canceled)

3. The harp of claim 1, wherein said hinge comprises a boss on one of said legs, and a matching clevis on the other of said legs, each said boss and said clevis having apertures therein for receipt of a hinge pin, said hinge pin oriented in a plane transverse to said harp.

4. The harp of claim 1, wherein each of said upper half and lower half of said leg is formed with a land thereon, said lands being aligned to abut one another to provide a stable leg of said harp.

5. The harp of claim 2, wherein said hinge comprises a boss on one of said legs, and a matching clevis on the other of said legs, each said boss and said clevis having apertures therein for receipt of a hinge pin, said hinge pin oriented in a plane transverse to said harp.

6. The harp of claim 2, wherein each of said upper half and lower half of said leg is formed with a land thereon, said lands being aligned to abut one another to provide a stable leg of said harp.
